(19) United States
(12) Patent Application Publication
(10) Pub. No.: US 2020/0100875 A1
(43) Pub. Date: Apr. 2, 2020

(54) BIOFIBER DENTAL IMPLANT

(71) Applicants: Luke Lu, (US); ILUMI Sciences Inc., Chantilly, VA (US)

(72) Inventors: Luke Lu, San Diego, CA (US); Kuan-Yu Lu, Taipei City (TW); Toshihiro Tokizawa, Tokyo (JP); I-Ching Lu, Taipei (TW)

(21) Appl. No.: 16/686,194

(22) Filed: Nov. 17, 2019

Related U.S. Application Data
(63) Continuation-in-part of application No. 14/576,219, filed on Dec. 19, 2014.

(51) Int. Cl. A61C 8/00; A61C 8/02

(52) U.S. Cl. CPC A61C 8/0013; A61C 8/0006

(57) ABSTRACT

Disclosed is a biofiber dental implant, comprising a fixture having a groove, for osseointegrating into a bone of a jaw or a skull; a peripheral junction having a through hole, connected to the fixture by the groove, for connecting an abutment supporting a dental prosthesis; and a middle member is disposed through the fixture and peripheral junction by the through hole. The fixture, the peripheral junction and middle member are made of multiple biofibers which consist a single bare fiber or a single constructed fiber. The single constructed fiber consists a core and either a single cladding or multiple claddings, and the clad and core are fused together to form the single constructed fiber.

### CROSS-REFERENCE TO RELATED APPLICATION

This is a continuation-in-part of co-pending U.S. patent application Ser. No. 14/576,219 filed on Dec. 19, 2014.

### BACKGROUND OF THE INVENTION

A dental implant (also known as an endosseous implant or fixture) is a surgical component that interfaces with the bone of the jaw or skull to support a dental prosthesis such as a crown, bridge, denture, facial prosthesis or to act as an orthodontic anchor. The basis for modern dental implants is a biological process called osseointegration where materials, such as titanium, form an intimate bond to bone. The implant fixture is first placed, so that it is likely to osseointegrate, then a dental prosthetic is added. A variable amount of healing time is required for osseointegration before either the dental prosthetic (a tooth, bridge or denture) is attached to the implant or an abutment is placed which will hold a dental prosthetic.

The primary use of dental implants is to support dental prosthetics. Modern dental implants make use of osseointegration, the biological process where bone attached tightly to the surface of specific materials such as titanium and some ceramics. The integration of implant and bone can support physical loads for decades without failure.

For individual tooth replacement, an implant abutment is first secured to the implant with an abutment screw. A crown (the dental prosthesis) is then connected to the abutment with dental cement, a small screw, or made with the abutment as one piece during fabrication. Dental implants, in the same way, can also be used to retain a multiple tooth dental prosthesis either in the form of a fixed bridge or removable dentures.

The long-term success of implants is determined, in part, by the forces they have to support. As implants have no periodontal ligament, there is no sensation of pressure when biting so the forces created are higher. To offset this, the location of implants must distribute forces evenly across the prosthetics they support. Concentrated forces can result in fracture of the bridgework, implant components, or loss of bone adjacent to the implant. The ultimate location of implants is based on both biologic (bone type, vital structures, health) and mechanical factors.

The design of implants has to, therefore, provide high tensile strength and dentin elasticity similar to natural tooth in order to account for a lifetime of real-world use in a person's mouth. Traditionally, titanium or zirconia (ceramic) is widely used for dental implants due to its high tensile strength. However, the titanium or zirconia (ceramic) material lacks dentin elasticity and is easily broken when hit.

Thus, there is a need for innovative design of dental implant to provide lifetime sustainability of real-world use.

### SUMMARY OF THE INVENTION

In accordance with exemplary embodiments of the present invention, a biofiber dental implant is proposed to solve the above-mentioned problem. A concept of the present invention is to provide a rugged dentin elastic structure for a biofiber dental implant. The present invention exploits mechanics of bioglass fibers and employs a woven method to provide said structure. The proposed bioglass fibers may be tensile-strength-enhanced and improve the osseointegration process. Among such biomaterials, bioglass fiber has recently been considered to be, potentially, an ideal biomaterial for dental implants and orthopedic fixation devices; this is due to its set of outstanding characteristics, including good mechanical properties, high impact resistance, biocompatible, malleable, long-term stability, non-magnetic status, low thermal conductivity and even magnetic resonance imaging (MRI) compatibility. Moreover, bioglass fiber has an elastic modulus of between 15 and 20 GPa, which is much closer to that of cortical/cancellous bone than titanium alloys, while it also has a relatively high tensile strength (4001200 MPa), which can be higher than that of the titanium metal (965 MPa).

Bioglass fiber is able to rejuvenate and repair cells in the body that has been damaged. Able to increase oxygen levels in the blood so that the quality of the blood that flows in the body to be good and healthy. Furthermore, bioglass fiber can also help maximize the absorption of nutrients by cells in the body.

Further, the bioglass fiber has great biocompatibility, its ability to avoid an immune reaction and fibrous encapsulation. This is significant, as it greatly reduces the risk of infections arising after surgery resulting in greater ease for both the patient and the doctor. Secondly, the bioglass has good osteoconductivity, this means that it is able to act as a scaffold for new bone growth that is perpetuated by the native bone, significantly speeding up the rate of bone growth. Thirdly, the bioglass fiber is biodegradable, it able to be decomposed by bacteria or enzymes inside the body. In addition, the bioglass fiber is doped with varying quantities of elements which can allow the successful bone regeneration.

According to a first aspect of the present invention, an exemplary biofiber dental implant is disclosed. The biofiber dental implant comprises a fixture, a peripheral junction and a middle member. The fixture has a groove and is for osseointegrating into a bone of a jaw or a skull; the peripheral junction has a through hole and is connected to the fixture by the groove, for connecting an abutment supporting a dental prosthesis; and the middle member is disposed through the fixture and peripheral junction by the through hole; wherein the fixture, the peripheral junction and middle member are made of a plurality of biofibers, consisting a single bare fiber or a single constructed fiber; wherein the single constructed fiber consists a core and either a single cladding or multiple claddings, and the single cladding or multiple claddings and core are fused together to form the single constructed fiber.

In a preferred embodiment, each of the plurality of biofibers is the single bare fiber, made of bioactive materials, such as bioglass fiber, collagen, hydroxyapatite (HA), or tricalcium phosphate (TCP). Alternatively, the plurality of biofibers also can be made of bioinert glass fiber with X-ray opacity or bioinert materials. When the biofiber dental implant is installed, each of the plurality of biofibers will begin to bone bonding process and the osseointegration. Since the plurality of biofibers of the biofiber dental implant contains bioactive material, much more intimate osseointegration can be provided by this woven method, as comparing to traditional coating method.

In a preferred embodiment, each of the plurality of biofibers is the single constructed fiber, and a coefficient of thermal expansion of multiple claddings of the single constructed fiber is gradually lower in order from an inner cladding to an outer cladding. Further, the single bare fiber and the single constructed fiber are made of either bioactive or bioinert material glass fiber and with or without X-ray opacity. Due to such natural property of fiber mechanics, such configuration is advantageous for the biofibers to be able to undertake a higher tensile force, and thus higher tensile strength of the biofiber dental implant can be provided. High tensile strength is crucial to a biofiber dental implant because the biofiber dental implant is frequently used and the external forces applied thereon are directionally inconsistent. Furthermore, the shapes of the single bare fiber and the constructed fiber, the core and the claddings can be randomly varied based on the user's requirements and preferences. In a preferred embodiment of the present invention, the single bare fiber and the single constructed fiber are formed with a round, a hexagonal, or a strip filament. In this embodiment, the core can either be formed with a round or a hexagonal filament. The claddings are composed of round, hexagonal, or strip filaments, which enhance the strength of the woven biofibers structures, but the present invention is not limited thereto. In a specific embodiment, the shell cladding is made of bioactive materials, such as bioglass, collagen, hydroxyapatite (HA), or tricalcium phosphate (TCP). While the surface of implant is in contact with the bone, the bioactive material will release from the surface by the ion exchange process and thus is in contact with the osteoblast for osseointegration. The claddings in this embodiment may be made of bioinert material so as to maintain the structure of biofiber dental implant.

In a preferred embodiment, the biofiber dental implant further comprises an adhesive polymer provided and reinforced within plurality of biofibers, made out of a thermosetting, thermoplastic or a biodegradable thermoplastic polymer.

In a preferred embodiment, wherein multiple bundles of biofibers are arranged as woven biofibers structures that each comprises a straight bundle center shaft, and multiple bundle interlaced biofibers which form a braid around the straight bundle center shaft. The straight bundle center shaft acts as a supporting component that provides an extra fixation for the multiple bundle interlaced biofibers, hence tensile strength in the direction of the straight bundle center shaft is higher by means of this center-enhanced mechanism, as comparing to traditional cross knitting mechanism. In addition to the round-shaped fiber, each biofiber may be hexagonal so as to provide even higher strength. Further, the biofiber dental implant can has high tensile strength and dentin elasticity at the same time. That is to say, the woven biofibers structures are better than traditional unidirectional one-piece structure regarding concentrated forces on the implant, and thus fractures can be prevented by using the woven biofibers structures.

In a preferred embodiment, multiple claddings comprises a middle cladding and a shell cladding; the middle cladding, the shell cladding and core are fused together to form the single constructed fiber; and a refractive indices of each cladding is lower than that of the core.

At least one cladding is made of bioinert material, and at least one cladding is made of bioactive material. For example, in a specific embodiment, the core and/or the middle cladding may be made of bioinert glass fiber with X-ray opacity, bioinert material, while the core is made of bioactive materials, such as bioactive glass, collagen, hydroxyapatite (HA), or tricalcium phosphate (TCP). In a specific embodiment, the core and/or the middle cladding may be made of bioactive materials, such as bioglass, collagen, hydroxyapatite (HA), or tricalcium phosphate (TCP), and the shell cladding may be made of bioinert glass fiber with X-ray opacity, bioinert material. In a specific embodiment, the core and/or the middle cladding may be formed with a round, or a hexagonal filament, while the shell cladding may be formed with a round, a hexagonal, or a strip filament in order to enhance the strength of the woven biofibers structures.

In a preferred embodiment, each of the plurality of biofibers comprises a light receiving end and a light emitting end, a light radiates through the light receiving end and the light is emitted from the light emitting end.

In a preferred embodiment, the biofiber dental implant has a light receiving part and a light emitting part, the light receiving part is made of the light receiving end and the light emitting part is made of the light emitting end, and both the light receiving part and the light emitting part is made of plurality of biofibers.

In a preferred embodiment, the core filled with a bioactive material or a bioinert material or an X-ray opaque bioinert material. Alternatively, the core filled without a bioactive material or a bioinert material or an X-ray opaque bioinert material.

In a preferred embodiment, the core and the cladding or multiple claddings are heated up fusion and draw down become the single constructed fiber.

These and other objectives of the present invention will undoubtedly become obvious to those of ordinary skill in the state of art after reading the following detailed description of the preferred embodiment that is illustrated in the various figures and drawings.

### BRIEF DESCRIPTION OF THE DRAWINGS

FIG. 1A is illustrating schematic diagram of a biofiber dental implant according to the present invention;

FIG. 1B is illustrating an exploded view of the biofiber dental implant according to the present invention;

FIG. 2A is a stereoscopical schematic view of a single bare fiber according to first embodiment of the present invention;

FIG. 2B is a stereoscopical schematic view of a single bare fiber according to second embodiment of the present invention;

FIG. 3A is a stereoscopical schematic view of a single constructed fiber according to third embodiment of the present invention;

FIG. 3B is a stereoscopical schematic view of a single constructed fiber according to fourth embodiment of the present invention;

FIG. 4A is a cross-sectional schematic view of a bundle of single bare fibers with adhesive polymer according to the present invention;

FIG. 4B is a cross-sectional schematic view of a bundle of single constructed fibers with adhesive polymer according to the second embodiment of the present invention;

FIG. 5A is a perspective view of a single constructed fiber according to fifth embodiment of the present invention;

FIG. 5B is a cross-sectional schematic view of a single constructed fiber according to fifth embodiment of the present invention;

FIG. 6A is illustrating a cross-sectional schematic view of single constructed fiber according to the fifth embodiment of the present invention;

FIG. 6B is illustrating a side cross-sectional schematic view of single constructed fiber according to the fifth embodiment of the present invention;

FIG. 7A is illustrating a schematic view of light traversing in the single constructed fiber according to a third embodiment of the present invention;

FIG. 7B is illustrating a schematic view of light traversing in the single constructed fiber according to the fifth embodiment of the present invention;

FIG. 8A is a cross-sectional schematic view of the single constructed fibers according a sixth embodiment of to the present invention;

FIG. 8B is a cross-sectional schematic view of the single constructed fibers according a seventh embodiment of to the present invention; and

FIG. 9 is illustrating a section-enlarged view of the biofiber dental implant according to the first embodiment of the present invention.

### DETAILED DESCRIPTION OF THE PREFERRED EMBODIMENTS

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

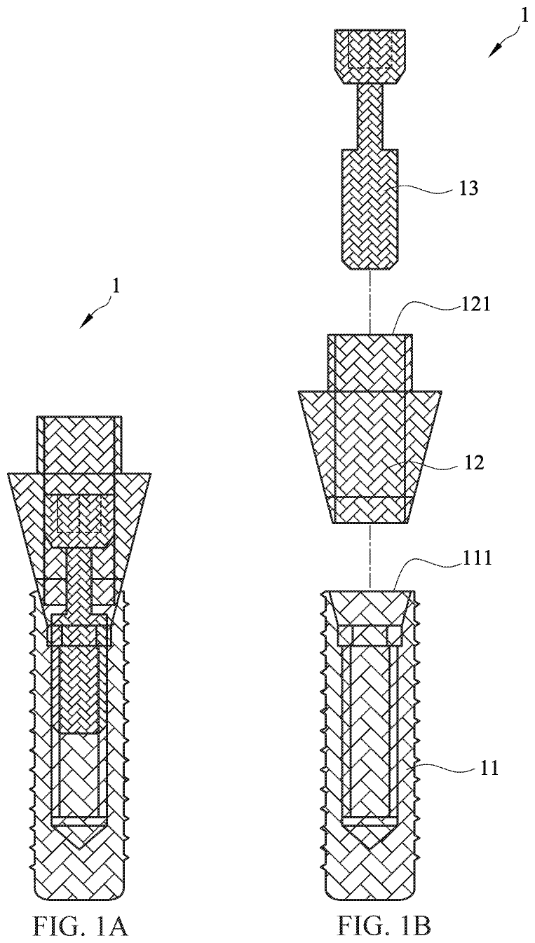

Please refer to FIG. 1A to FIG. 1B, FIG. 1A is illustrating schematic diagram of a biofiber dental implant according to a first embodiment of the present invention; and FIG. 1B is illustrating an exploded view of the biofiber dental implant according to the first embodiment of the present invention.

As shown in FIG. 1A to FIG. 1B, a biofiber dental implant 1 comprises a fixture 11, a peripheral junction 12 and a middle member 13. First, the fixture 11 has a groove 111 and is for osseointegrating into a bone of a jaw or a skull; and the peripheral junction 12 has a through hole 121 and is connected to the fixture 11 by the groove 111, for connecting an abutment supporting a dental prosthesis. Secondly, the middle member 13 is disposed through the fixture 11 and peripheral junction 12 by the through hole 121; wherein the fixture 11, the peripheral junction 12 and middle member 13 are made of an adhesive polymer matrix reinforced with biofibers.

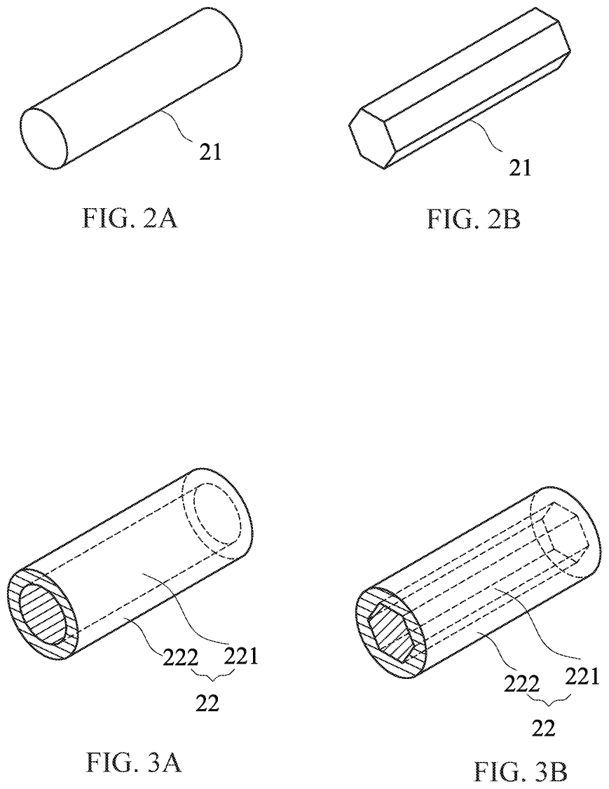

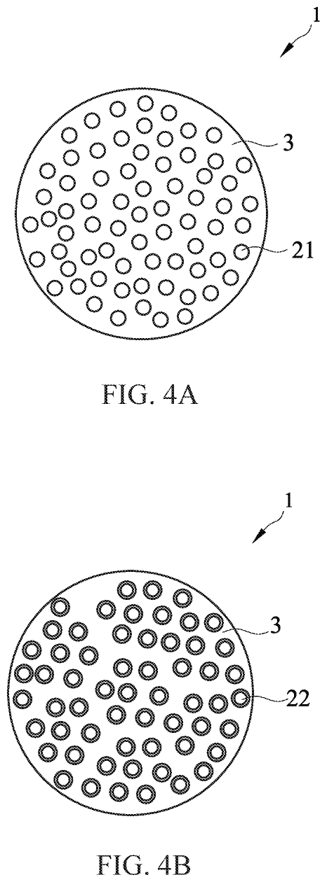

Please refer to FIG. 2A to FIG. 4B, FIG. 2A is a stereoscopical schematic view of a single bare fiber according to first embodiment of the present invention; FIG. 2B is a stereoscopical schematic view of a single bare fiber according to second embodiment of the present invention; FIG. 3A is a stereoscopical schematic view of a single constructed fiber according to third embodiment of the present invention; FIG. 3B is a stereoscopical schematic view of a single constructed fiber according to fourth embodiment of the present invention; FIG. 4A is a cross-sectional schematic view of a bundle of single bare fibers with adhesive polymer according to the present invention; FIG. 4B is a cross-sectional schematic view of a bundle of single constructed fibers with adhesive polymer according to the second embodiment of the present invention.

As shown in FIG. 2A to FIG. 4B, a bundle of biofibers consists a single bare fiber 21 or a single constructed fiber 22; wherein the single constructed fiber 22 consists a core 221 and either a single cladding 222 or multiple claddings 222, and the single cladding 222 or multiple claddings 222 and core 221 are fused together to form the single constructed fiber 22. Further, the adhesive polymer 3 provided and reinforced within a bundle of biofibers, the adhesive polymer 3 is made out of a thermosetting, thermoplastic or a biodegradable thermoplastic polymer. As shown in FIG. 4A and FIG. 4B, the single bare fiber 21 and the single constructed fiber 22 are fixed in the adhesive polymer 3.

Furthermore, the single bare fiber 21 and the single constructed fiber 22 may be formed with a round, a hexagonal. The purpose of forming the hexagonal fibers is to provide higher tensile strength of constructed biofibers for the biofiber dental implant 1. In these embodiments, multiple bundles of biofibers 2 may be made of bioactive materials, such as bioglass, collagen, hydroxyapatite (HA), or tricalcium phosphate (TCP). When the biofiber dental implant 1 is installed, each of the plurality of biofibers 2 will begin to bone bonding process and the osseointegration. Since the plurality of biofibers 2 used in the embodiment are bioactive, the adhesive polymer 3 should be made of a bioinert material to maintain the structure of the biofiber dental implant 1, but the present invention is not limited thereto. The plurality of biofibers 2 may be made of a bioinert glass fiber with X-ray opacity or a bioinert material.

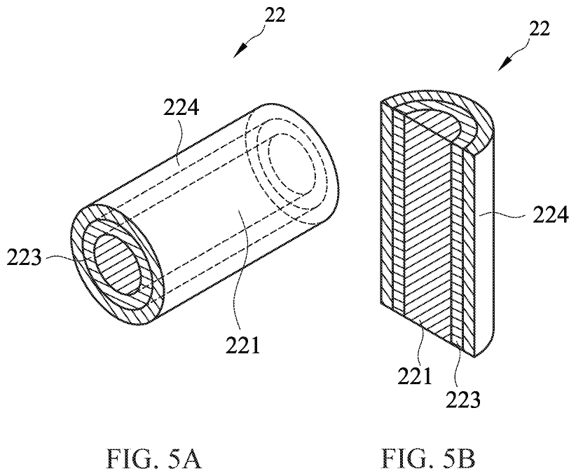

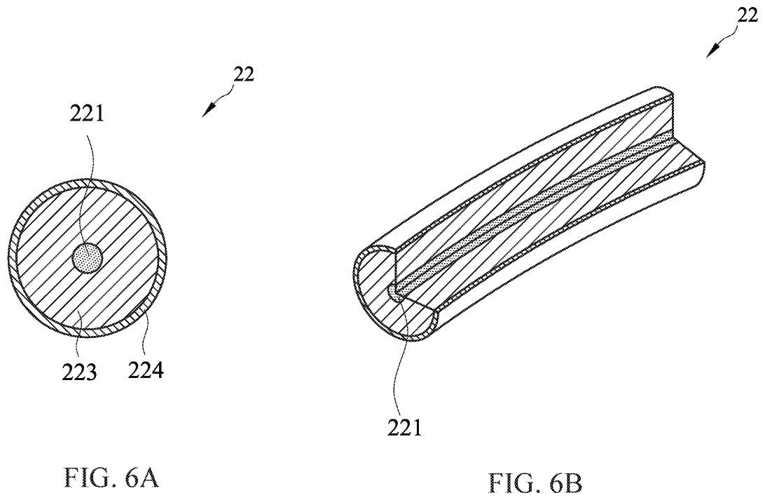

Please refer to FIG. 5A to FIG. 6B, FIG. 5A is a perspective view of a single constructed fiber according to fifth embodiment of the present invention; FIG. 5B is a cross-sectional schematic view of a single constructed fiber according to fifth embodiment of the present invention; FIG. 6A is illustrating a cross-sectional schematic view of single constructed fiber according to the fifth embodiment of the present invention; and FIG. 6B is illustrating a side cross-sectional schematic view of single constructed fiber according to the fifth embodiment of the present invention.

As shown in FIG. 5A to FIG. 6B, multiple claddings 222 comprises a middle cladding 223 and a shell cladding 224; the middle cladding 223, the shell cladding 224 and the core 221 are fusion together to form the single constructed fiber 22; and the refractive indices of each cladding 222 is lower than that of the core 221. Further, a coefficient of thermal expansion of the single constructed fiber 22 is gradually lower in order from an inner cladding to an outer cladding. The coefficient of thermal expansion of the middle cladding 223 is lower than that of the core 221, and the coefficient of thermal expansion of the shell cladding 224 is lower than that of the middle cladding 223. The single constructed fiber 22 in FIG. 6A is a double-cladding structure, and the merit of this double-cladding structure is to provide higher tensile strength; and thus higher tensile strength of the biofiber dental implant 1 can be provided. In the double-cladding structure, the core 221 or at least one cladding is made of bioinert material, and the core 221 or at least one cladding is made of bioactive material. In a specific embodiment, the core 221 and/or the middle cladding 223 or shell cladding 224 may be a bioinert glass fiber with X-ray opacity or a bioinert material, and the bioactive materials is made of bioglass, collagen, hydroxyapatite (HA), or tricalcium phosphate (TCP). The merit of this double-cladding structure is that when the shell cladding 224 osseointegrates with bones, one-cladding structure constituted by the remained core 221 and middle cladding 223 can be still remained, so as to provide higher tensile strength. In a specific embodiment, the core 221 and/or the middle cladding 223 may be formed with a round, or a hexagonal filament, while the shell cladding 224 may be formed with a round, a hexagonal, or a strip filament in order to enhance the strength of the woven biofibers structures 223. In another embodiment, as shown in FIG. 6A and FIG. 6B, the core 221 and/or the middle cladding 223 may be made of bioactive materials, such as bioglass, collagen, hydroxyapatite (HA), or tricalcium phosphate (TCP), and the shell cladding 224 may be made of bioinert glass fiber with X ray opacity or the bioinert material. Therefore, the bioactive material may be released from the core 221 or the middle cladding 223 and thus is in contact with the osteoblast of the bone for osseointegration.

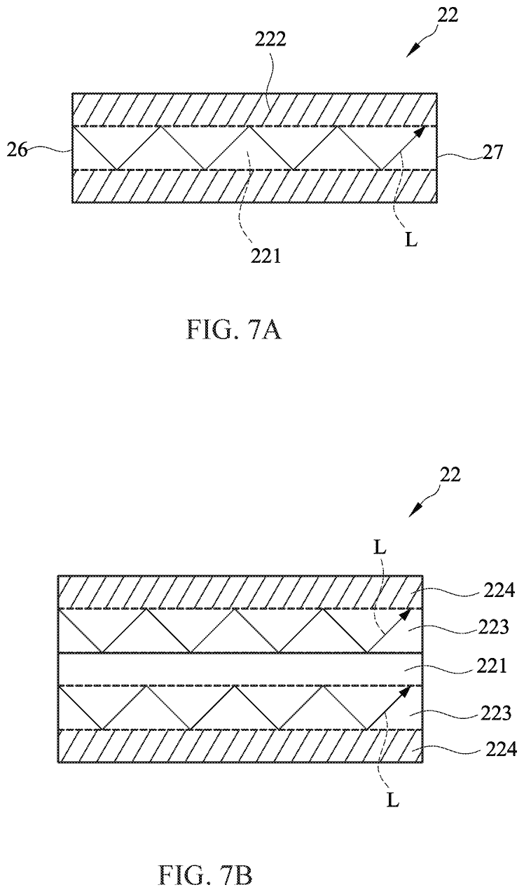

Please refer to FIG. 7A and FIG. 7B, FIG. 7A is illustrating a schematic view of light traversing in the single constructed fiber according to a third embodiment of the present invention; and FIG. 7B is illustrating a schematic view of light traversing in the single constructed fiber according to the fifth embodiment of the present invention.

As shown in FIG. 7A and FIG. 7B, the single constructed fiber 22 comprises a light receiving end 26 and a light emitting end 27, a light L radiates through the light receiving end 26 and the light L is emitted from the light emitting end 27. The biofiber dental implant 1 has a light receiving part and a light emitting part, the light receiving part is made of the light receiving end 26 and the light emitting part is made of the light emitting end 27, and both the light receiving part and the light emitting part is made of the single constructed fiber 22. As shown in FIG. 7A, the refractive indices of the cladding 222 is lower than that of the core 221; and the coefficient of thermal expansion of the cladding 222 is lower than that of the core 221. As shown in FIG. 7B, the refractive indices of the middle cladding 223 is greater than that of the core 221; and the refractive indices of the shell cladding 224 is lower than that of the middle cladding 223. Further, the coefficient of thermal expansion of the middle cladding 223 is lower than that of the core 221, and the coefficient of thermal expansion of the shell cladding 224 is lower than that of the middle cladding 223.

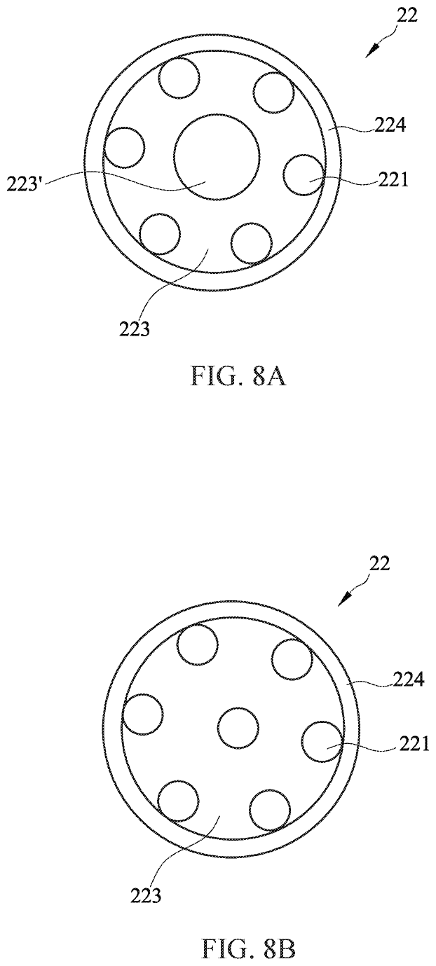

Please refer to FIG. 8A and FIG. 8B, FIG. 8A is a cross-sectional schematic view of the single constructed fibers according a sixth embodiment of to the present invention; and FIG. 8B is a cross-sectional schematic view of the single constructed fibers according a seventh embodiment of to the present invention.

As shown in FIG. 8A, the single constructed fiber 22 has six pieces of the core 221 made of the bioactive materials, such as bioglass fiber; the middle cladding 223′ is one piece of a high index material and surrounded the middle cladding 223 made of bioinert material glass fiber with X-ray opacity; and the shell cladding 224 is made of the bioinert material. Furthermore, as shown in FIG. 8B, the single constructed fiber 22 has seven pieces of the core 221 made of the bioactive materials, such as bioglass fiber, and surrounded the middle cladding 223 made of bioinert material glass fiber with X-ray opacity; and the shell cladding 224 is made of the bioinert material.

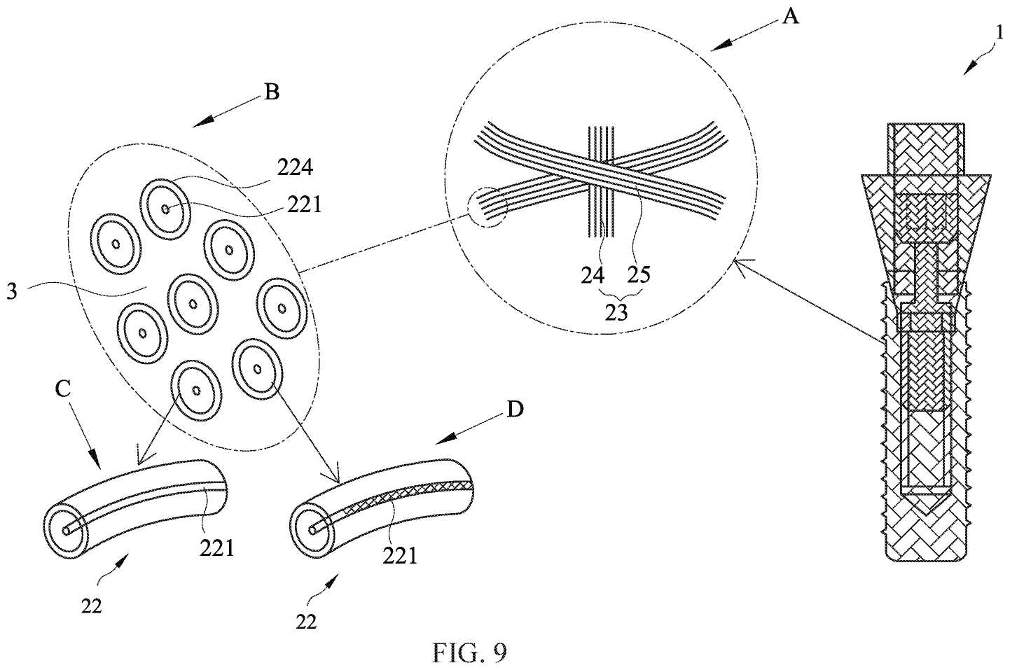

Please refer to FIG. 9, FIG. 9 is illustrating a section-enlarged view of the biofiber dental implant according to the first embodiment of the present invention.

As shown in the sub-figure A of FIG. 9, the plurality of biofibers 2 are arranged as woven biofibers structures 23 that each comprises a straight bundle center shaft 24, and multiple bundle interlaced biofibers 25 which form a braid around the straight bundle center biofiber shaft 24. The bundle straight center biofiber shaft 24 is provided straightly through the woven biofibers structures 23, while the multiple bundle interlaced biofibers 25 are interlaced-knitted around straight bundle center shaft 24. This “*” pattern of sub-figure A provides additional fixation for the multiple bundle interlaced biofibers 25 and higher tensile strength in bidirection and thus more rugged structure is yielded, as comparing to traditional unidirection structure. In the sub-figure B, the sub-figure B is a cross-sectional schematic view of the woven biofibers structures 23. In addition, at least one of the core 221 and shell cladding 224 is made of materials with X-ray opacity, such that the biofiber dental implant 1 can be shown up on a X-ray scan. Please note that the above embodiments are described for illustrative purpose only, and are not meant for limitations of the present invention. In other embodiments, the biofiber dental implant 1 can be formed as a structure more than double-claddings, various shapes and various materials can be selectively used as each cladding, while one of those claddings is made of bioinert materials for maintaining the structure of the biofiber dental implant 1, and it is enough for osseointegration that only one cladding of plurality biofibers is made of bioactive material. For example, plurality biofibers used in the biofiber dental implant 1 is ten claddings, each cladding can be respectively formed with a round, a hexagonal, or a strip filament, and each cladding can be respectively made of bioactive materials (bioglass, collagen, hydroxyapatite (HA), tricalcium phosphate (TCP)), bioinert materials, or materials with Xray opacity, while at least one cladding is made of bioinert materials, and at least one cladding is made of bioactive material.

Moreover, as shown in the sub-figure C of FIG. 9, the core 221 filled without a bioactive material or a bioinert material or an X-ray opaque bioinert material. In another preferred embodiment, as shown in the sub-figure D of FIG. 9, the core 221 partially filled with a bioactive material or a bioinert material or an X-ray opaque bioinert material.

Those skilled in the art will readily observe that numerous modifications and alterations of the device and method may be made while retaining the teachings of the invention. Accordingly, the above disclosure should be construed as limited only by the metes and bounds of the appended claims.

I claim:

1. A biofiber dental implant, comprising:
a fixture having a groove, for osseointegrating into a bone of a jaw or a skull;
a peripheral junction having a through hole, connected to the fixture by the groove, for connecting an abutment supporting a dental prosthesis; and
a middle member is disposed through the fixture and peripheral junction by the through hole;
wherein the fixture, the peripheral junction and middle member are made of multiple biofibers, consisting a single bare fiber or a single constructed fiber;
wherein the single constructed fiber consists a core and either a single cladding or multiple claddings, and the clad and core are fused together to form the single constructed fiber.

2. The biofiber dental implant of claim 1, further comprises an adhesive polymer provided and reinforced within multiple biofibers, made out of a thermosetting or a thermoplastic polymer.

3. The biofiber dental implant of claim 1, wherein multiple bundle of biofibers are arranged as woven biofibers structures that each comprises a straight bundle center shaft, and multiple bundle interlaced biofibers which form a braid around the straight bundle center shaft.

4. The biofiber dental implant of claim 1, wherein the single bare fiber and the single constructed fiber are made of either bioactive or bioinert material glass fiber and with or without X-ray opacity.

5. The biofiber dental implant of claim 1, wherein the multiple claddings comprises a middle cladding and a shell cladding; the middle cladding, the shell cladding and core are fused together to form the single constructed fiber; and a refractive indices of each cladding is lower than the core.

6. The biofiber dental implant of claim 1, wherein each of the plurality of biofibers comprises a light receiving end and a light emitting end, a light radiates through the light receiving end and the light is emitted from the light emitting end; and the biofiber dental implant has a light receiving part and a light emitting part, the light receiving part is made of the light receiving end and the light emitting part is made of the light emitting end, and both the light receiving part and the light emitting part is made of the plurality of biofibers.

7. The biofiber dental implant of claim 1, wherein the core partially filled with a bioactive material or a bioinert material or an X-ray opaque bioinert material; or the core filled with or without a bioactive material or a bioinert material or an X-ray opaque bioinert material.

8. The biofiber dental implant of claim 1, wherein the core and the cladding or multiple claddings are heated up fusion and draw down become the single constructed fiber.
